(19) United States
(12) Patent Application Publication
(10) Pub. No.: US 2026/0214692 A1
(43) Pub. Date: Jul. 23, 2026

(54) INTERFERENCE AVOIDANCE FOR SUBBAND FULL DUPLEX

(71) Applicant: QUALCOMM Incorporated, San Diego, CA (US)

(72) Inventors: Qian ZHANG, Basking Ridge, NJ (US); Tao LUO, San Diego, CA (US); Junyi LI, Greentown, PA (US)

(21) Appl. No.: 19/376,728

(22) Filed: Oct. 31, 2025

Related U.S. Application Data
(60) Provisional application No. 63/746,859, filed on Jan. 17, 2025.

(51) Int. Cl. H04W 72/541; H04L 5/14; H04W 72/044

(52) U.S. Cl. CPC H04W 72/541; H04L 5/1461; H04W 72/044

(57) ABSTRACT

Various aspects of the present disclosure generally relate to wireless communication. In some aspects, a user equipment (UE) may receive information for an uplink band and a downlink band, where the downlink band does not include a harmonic frequency of a fundamental frequency of the uplink band. The UE may communicate a message using the uplink band or the downlink band. Numerous other aspects are described.

### CROSS-REFERENCE TO RELATED APPLICATION

This Patent Application claims priority to U.S. Provisional Patent Application No. 63/746,859, filed on January 17, 2025, entitled “INTERFERENCE AVOIDANCE FOR SUBBAND FULL DUPLEX,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for avoiding interference for subband full duplex.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving information for an uplink band and a downlink band, where the downlink band does not include a harmonic frequency of a fundamental frequency of the uplink band. The method may include communicating a message using the uplink band or the downlink band.

Some aspects described herein relate to a method of wireless communication performed by a network entity. The method may include transmitting information for an uplink band and a downlink band, where the downlink band does not include a harmonic frequency of a fundamental frequency of the uplink band. The method may include communicating a message using the uplink band or the downlink band.

Some aspects described herein relate to an apparatus for wireless communication at a UE. The apparatus may include one or more memories and one or more processors coupled to the one or more memories. The one or more processors may be individually or collectively configured to receive information for an uplink band and a downlink band, where the downlink band does not include a harmonic frequency of a fundamental frequency of the uplink band. The one or more processors may be individually or collectively configured to communicate a message using the uplink band or the downlink band.

Some aspects described herein relate to an apparatus for wireless communication at a network entity. The apparatus may include one or more memories and one or more processors coupled to the one or more memories. The one or more processors may be individually or collectively configured to transmit information for an uplink band and a downlink band, where the downlink band does not include a harmonic frequency of a fundamental frequency of the uplink band. The one or more processors may be individually or collectively configured to communicate a message using the uplink band or the downlink band.

Some aspects described herein relate to a non-transitory computer-readable medium that stores a set of instructions for wireless communication by a UE. The set of instructions, when executed by one or more processors of the UE, may cause the UE to receive information for an uplink band and a downlink band, where the downlink band does not include a harmonic frequency of a fundamental frequency of the uplink band. The set of instructions, when executed by one or more processors of the UE, may cause the UE to communicate a message using the uplink band or the downlink band.

Some aspects described herein relate to a non-transitory computer-readable medium that stores a set of instructions for wireless communication by a network entity. The set of instructions, when executed by one or more processors of the network entity, may cause the network entity to transmit information for an uplink band and a downlink band, where the downlink band does not include a harmonic frequency of a fundamental frequency of the uplink band. The set of instructions, when executed by one or more processors of the network entity, may cause the network entity to communicate a message using the uplink band or the downlink band.

Some aspects described herein relate to an apparatus for wireless communication. The apparatus may include means for receiving information for an uplink band and a downlink band, where the downlink band does not include a harmonic frequency of a fundamental frequency of the uplink band. The apparatus may include means for communicating a message using the uplink band or the downlink band.

Some aspects described herein relate to an apparatus for wireless communication. The apparatus may include means for transmitting information for an uplink band and a downlink band, where the downlink band does not include a harmonic frequency of a fundamental frequency of the uplink band. The apparatus may include means for communicating a message using the uplink band or the downlink band.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated base station architecture.

FIG. 3 is a diagram illustrating examples of full-duplex (FD) communication in a wireless network.

FIG. 4 is a diagram illustrating an example of avoiding self-interference with subband FD (SBFD).

FIG. 5 is a diagram illustrating an example of avoiding self-interference with SBFD.

FIG. 6 is a diagram illustrating an example associated with avoiding self-interference with SBFD.

FIG. 7 is a diagram illustrating an example process performed, for example, at a user equipment (UE) or an apparatus of a UE.

FIG. 8 is a diagram illustrating an example process performed, for example, at a network entity or an apparatus of a network entity.

FIG. 9 is a diagram of an example apparatus for wireless communication.

FIG. 10 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Subband full-duplex (SBFD) may increase an uplink duty cycle, improve uplink coverage, and reduce latency, because it is possible to transmit an uplink signal in an uplink subband in downlink only slots or in flexible slots. SBFD may enhance system capacity, resource utilization, and spectrum efficiency. SBFD may enable flexible and dynamic uplink and downlink resource adaptation according to uplink and downlink traffic in a robust manner. For frequency division duplex (FDD) operation or inter-band carrier aggregation (CA) or dual connectivity (DC), UE implementations for a radio frequency (RF) front end may have transmissions that cause a jammer condition for the UE’s own receiver. For example, the UE may backoff an analog-to-digital converter (ADC) setpoint of the UE, assuming its transmitter is always transmitting.

For a specific band combination for inter-band CA or DC (e.g., main sub-6 GHz 5G band (C band) and main new 6G band (6-8 GHz)), the self-interference affecting transmission and reception between those two bands at the UE and/or the network entity may be relatively strong if there is flexible time division duplexing (TDD). Harmonics of a frequency include integer multiples of an original frequency. For a UE that is configured with uplink transmission in the C band (e.g., at 3.5 GHz), the UE may cause self-interference for its own downlink band reception (e.g., at 7 GHz band) due to the second harmonic of the fundamental frequency (f1 = 3.5 GHz, 2 × f1 = 7 GHz). There may be other harmonic frequencies, such as the 3rd harmonic (3 × f1). Self-interference from harmonic frequencies may degrade communications, which wastes signaling resources and reduces throughput.

Various aspects relate generally to SBFD communications. Some aspects more specifically relate to a network entity that indicates an uplink band and a downlink band in information to a UE in which the downlink band does not include a harmonic frequency of a fundamental frequency of the uplink band. The UE may use the uplink band or the downlink band to communicate a message (transmit in the uplink band or receive in the downlink band).

Particular aspects of the subject matter described in this disclosure can be implemented to realize one or more of the following potential advantages. By having a network entity indicate a downlink band that accounts for harmonics of an uplink band, the UE may avoid self-interference and improve communications. As a result, signaling resources are conserved and throughput is increased.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

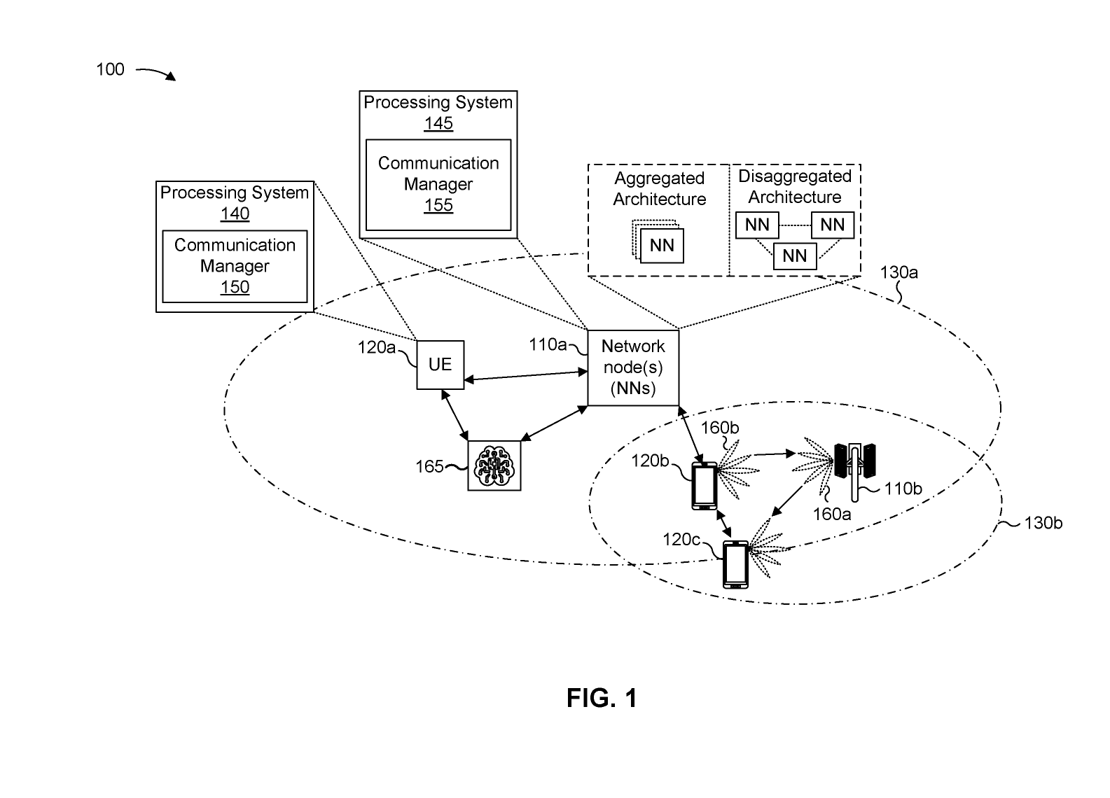

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

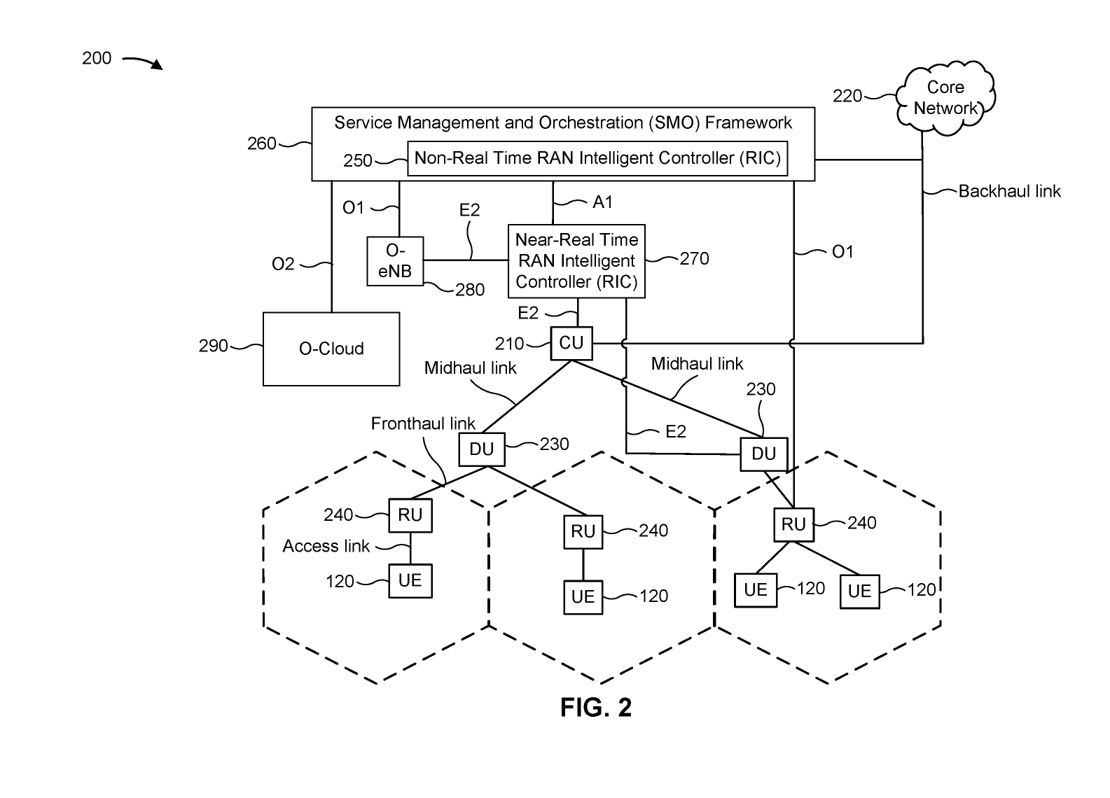

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., a UE 120) may include a communication manager 150. As described in more detail elsewhere herein, the communication manager 150 may receive information for an uplink band and a downlink band, where the downlink band does not include a harmonic frequency of a fundamental frequency of the uplink band; and communicate a message using the uplink band or the downlink band. Additionally, or alternatively, the communication manager 150 may perform one or more other operations described herein.

In some aspects, a network entity (e.g., a network node 110) may include a communication manager 155. As described in more detail elsewhere herein, the communication manager 155 may transmit information for an uplink band and a downlink band, where the downlink band does not include a harmonic frequency of a fundamental frequency of the uplink band; and communicate a message using the uplink band or the downlink band. Additionally, or alternatively, the communication manager 155 may perform one or more other operations described herein.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

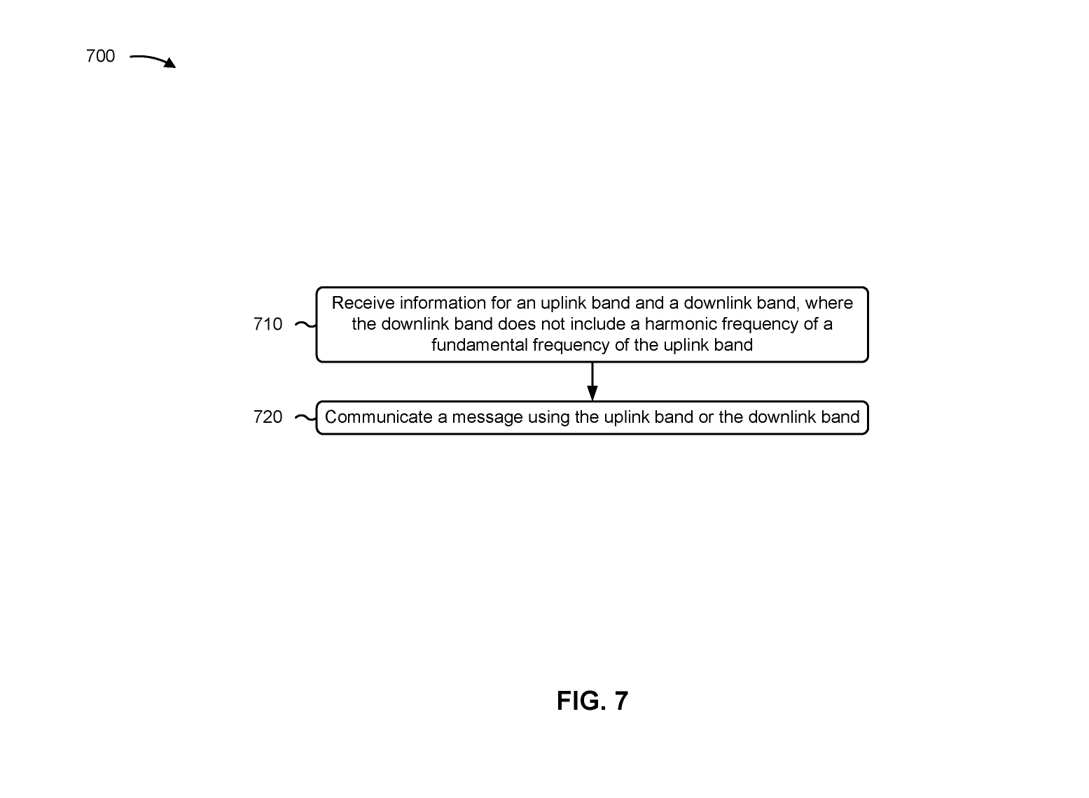

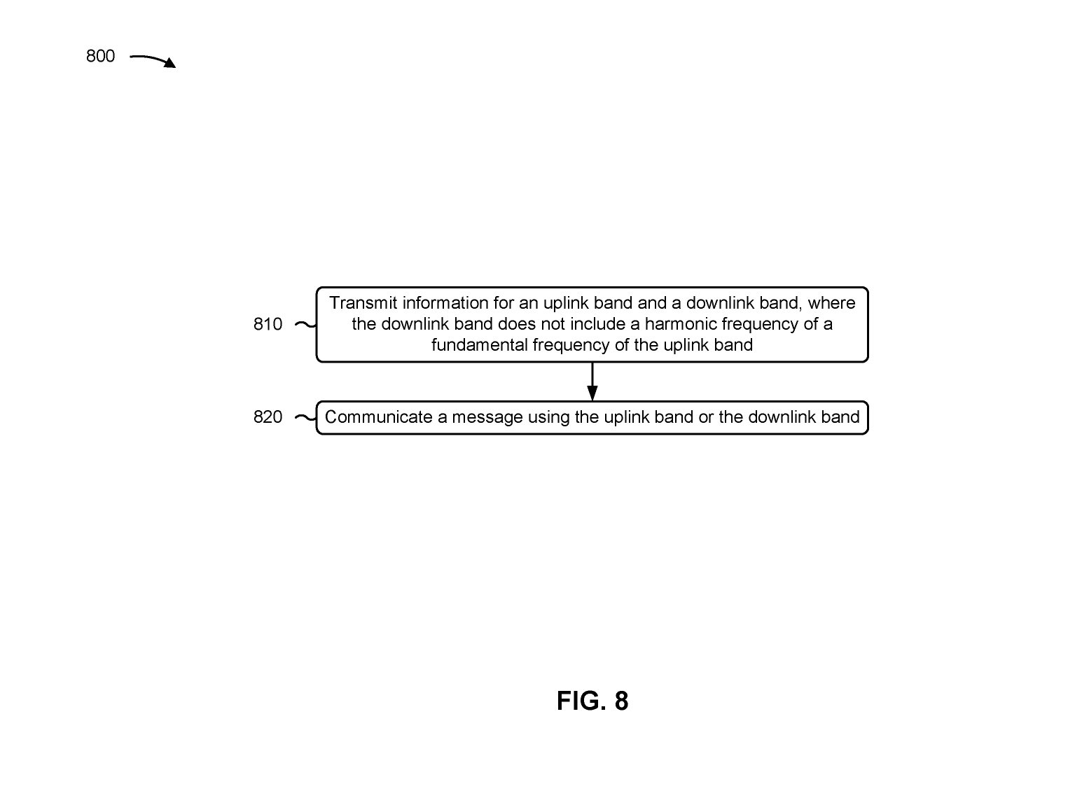

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with avoiding interference for SBFD, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

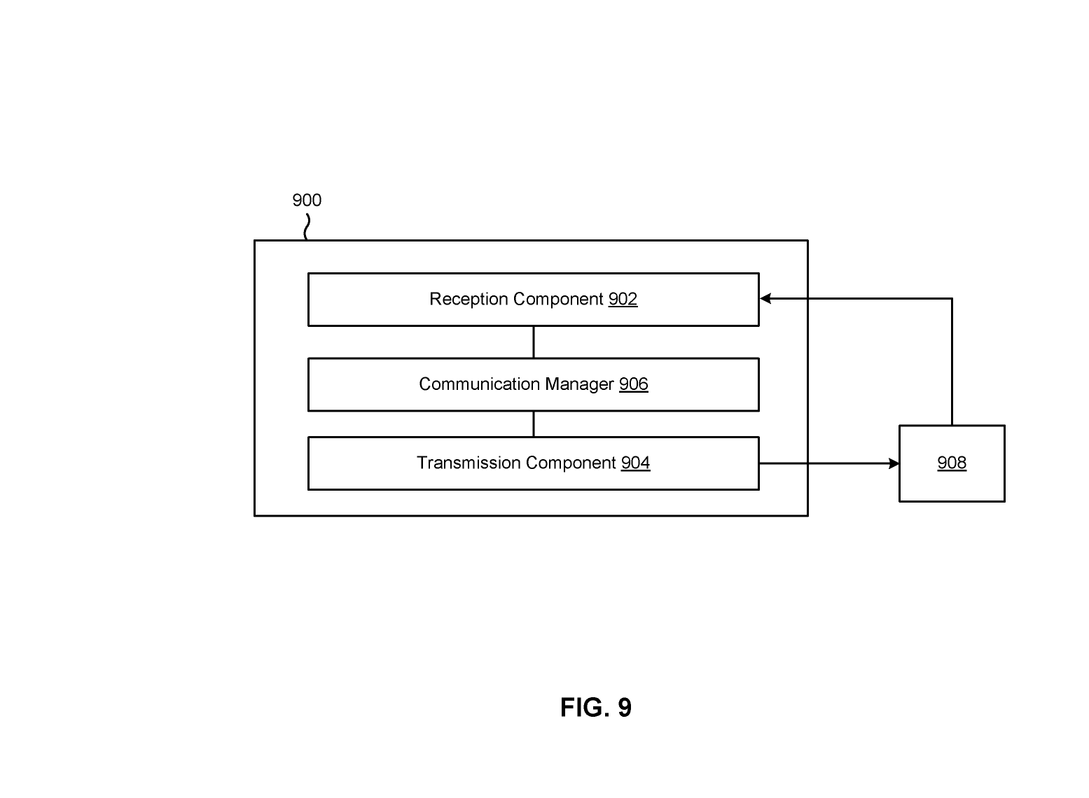

In some aspects, a UE (e.g., a UE 120) includes means for receiving information for an uplink band and a downlink band, where the downlink band does not include a harmonic frequency of a fundamental frequency of the uplink band; and/or means for communicating a message using the uplink band or the downlink band. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9, among other examples.

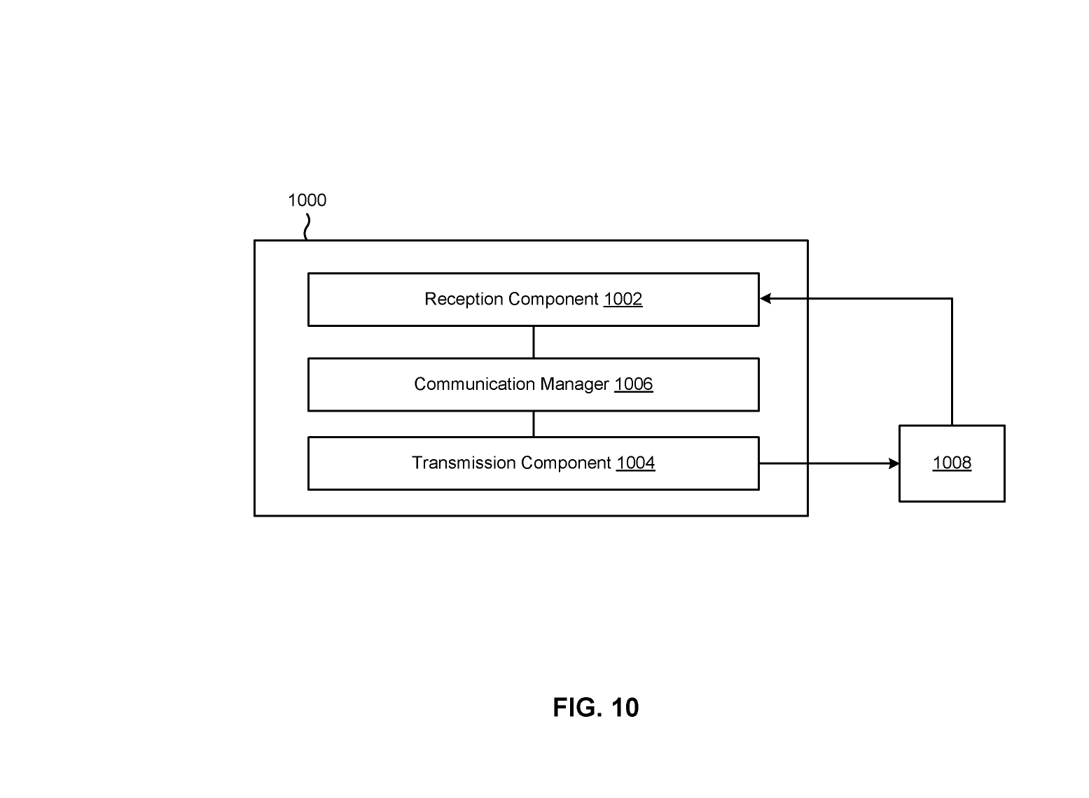

In some aspects, a network entity (e.g., a network node 110) includes means for transmitting information for an uplink band and a downlink band, where the downlink band does not include a harmonic frequency of a fundamental frequency of the uplink band; and/or means for communicating a message using the uplink band or the downlink band. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

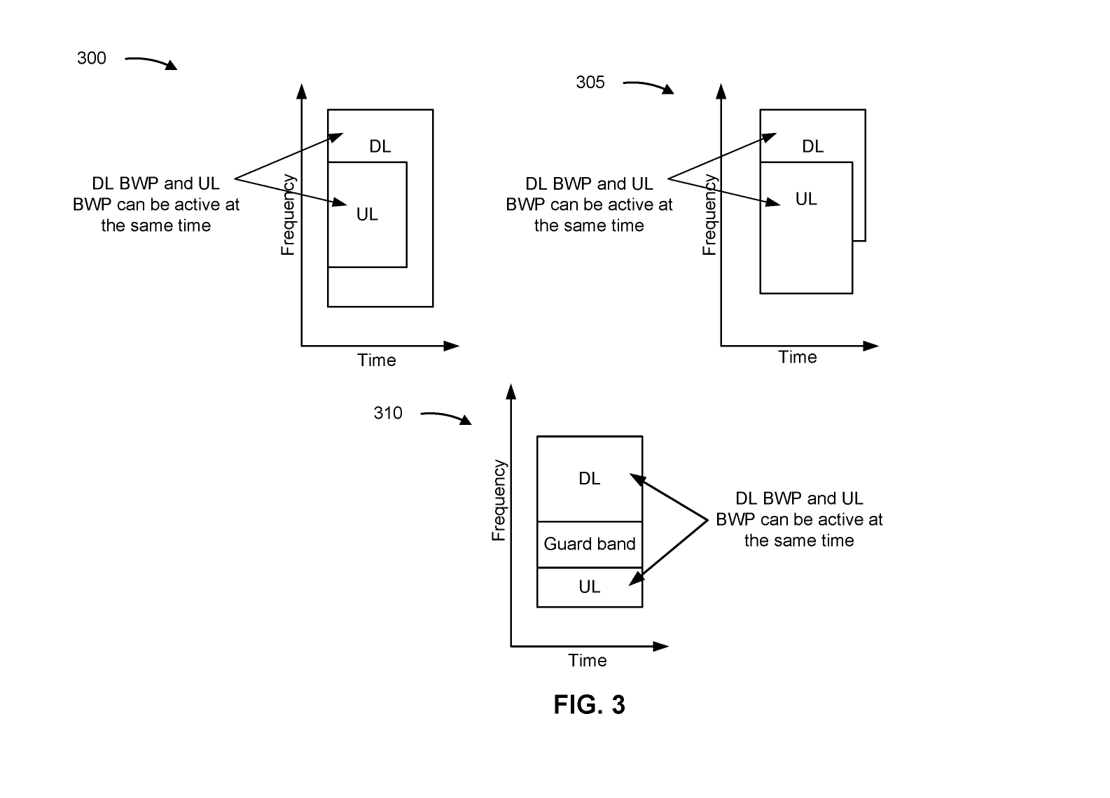

FIG. 3 is a diagram illustrating examples 300, 305, and 310 of full-duplex (FD) communication in a wireless network. “FD communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). Half-duplex communication, or “HD communication”, in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a base station and receive a downlink communication from the base station on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “subband frequency division duplex (SBFDD)” or “flexible duplex.” In SBFD, a UE may transmit an uplink communication to a base station and receive a downlink communication from the base station at the same time, but on different frequency resources. For example, the different frequency resources may be subbands of a frequency band, such as a TDD band. In this case, the frequency resources used for downlink communication may be separated from the frequency resources used for uplink communication, in the frequency domain, by a guard band.

SBFD may increase an uplink duty cycle, improve uplink coverage, and reduce latency, because it is possible to transmit an uplink signal in an uplink subband in downlink only or in flexible slots. SBFD may enhance system capacity, resource utilization, and spectrum efficiency. SBFD may enable flexible and dynamic uplink and downlink resource adaption according to uplink and downlink traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and msg3. A random access channel (RACH) configuration may indicate a quantity of synchronization signal blocks (SSBs) per RACH occasion (RO) and power information for PRACH messages (e.g., preambles).

For inter-band CA or DC, UE implementations for a RF front end may have transmissions that cause a jammer condition for its own receiver. For example, the UE may backoff its ADC setpoint assuming its transmitter is always transmitting.

For a specific band combination for inter-band CA or DC (e.g., main sub-6 GHz 5G band (C band) and main new 6G band (6-8 GHz)), the self-interference between transmission and reception between those two bands at the UE and/or the network entity may be relatively strong if there is flexible time division duplexing (TDD). Harmonics of a frequency may include integer multiples of an original frequency. For a UE that is configured with uplink transmission in the C band (e.g., at 3.5 GHz), the UE may cause self-interference for its own downlink band reception (e.g., at 7 GHz band) due to the second harmonic of the fundamental frequency (f1 = 3.5 GHz, 2 × f1 = 7 GHz). There may be other harmonic frequencies, such as the 3rd harmonic (3 × f1). Self-interference from harmonic frequencies may degrade communications, which wastes signaling resources and reduces throughput.

As indicated above, FIG. 3 is provided as an example. Other examples may differ from what is described with respect to FIG. 3

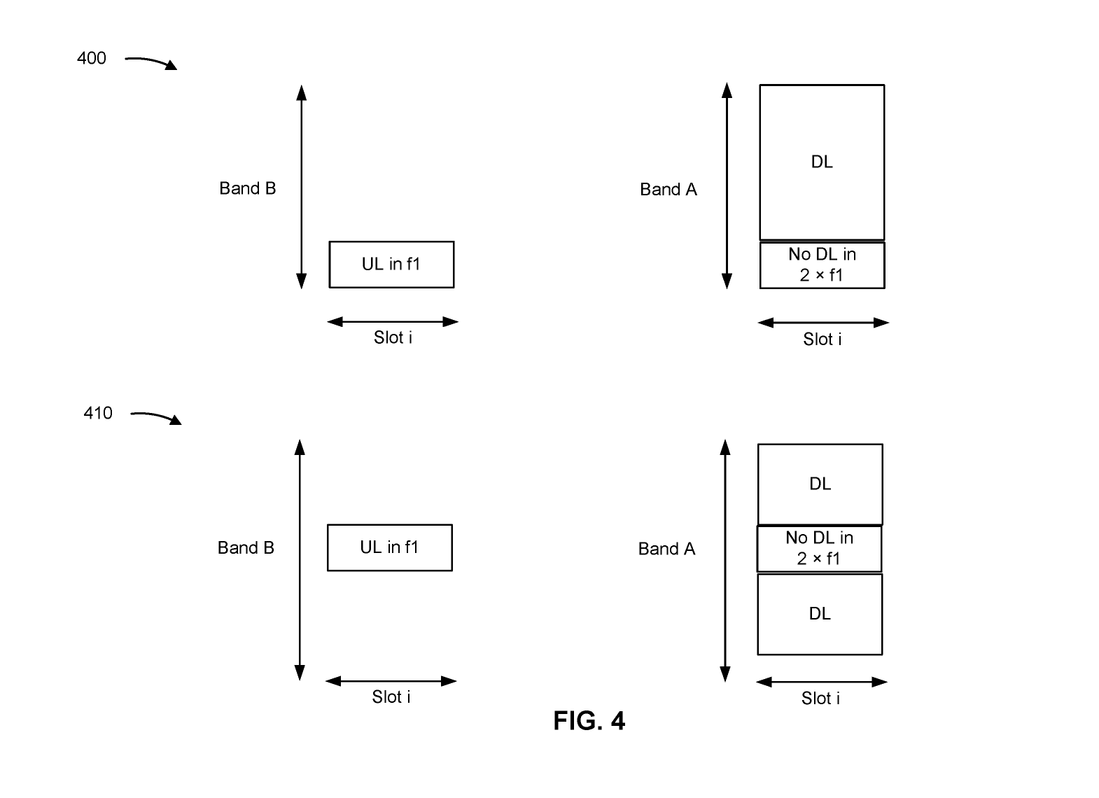

FIG. 4 is a diagram illustrating an example 500 of avoiding self-interference with SBFD.

According to various aspects described herein, a network entity may indicate an uplink band and a downlink band in information to a UE in which the downlink band does not include a harmonic frequency of a fundamental frequency of the uplink band. The UE may use the uplink band or the downlink band to communicate a message (transmit in the uplink band or receive in the downlink band). In this way, the UE may avoid self-interference and improve communications. As a result, signaling resources are conserved and throughput is increased.

Example 400 shows enabling subband downlink reception in band A (6G 6-8 GHz band) while there is potential or actual subband/full band transmission in uplink in band B (5G C band) in the same device. The uplink band at frequency f1 may cause self-interference for inter-band CA/DC for downlink reception in a downlink band of band A.

To avoid the self-interference, a network entity (e.g., gNB) may semi-statically or dynamically configure the UE with time and/or frequency resources for downlink reception in Band A (in-band in second harmonic f2 = 2 x f1) that are not used due to uplink transmission in Band B (in f1) in the same slot i and/or frequency resources. That is, the downlink band may not include a harmonic frequency of the fundamental frequency (e.g., central frequency, reference frequency) of the frequency of the uplink band. Example 410 shows that the harmonic frequency of the uplink band may be in a different location, such as a middle of a potential downlink band, or between two downlink subbands.

As indicated above, FIG. 4 is provided as an example. Other examples may differ from what is described with regard to FIG. 4.

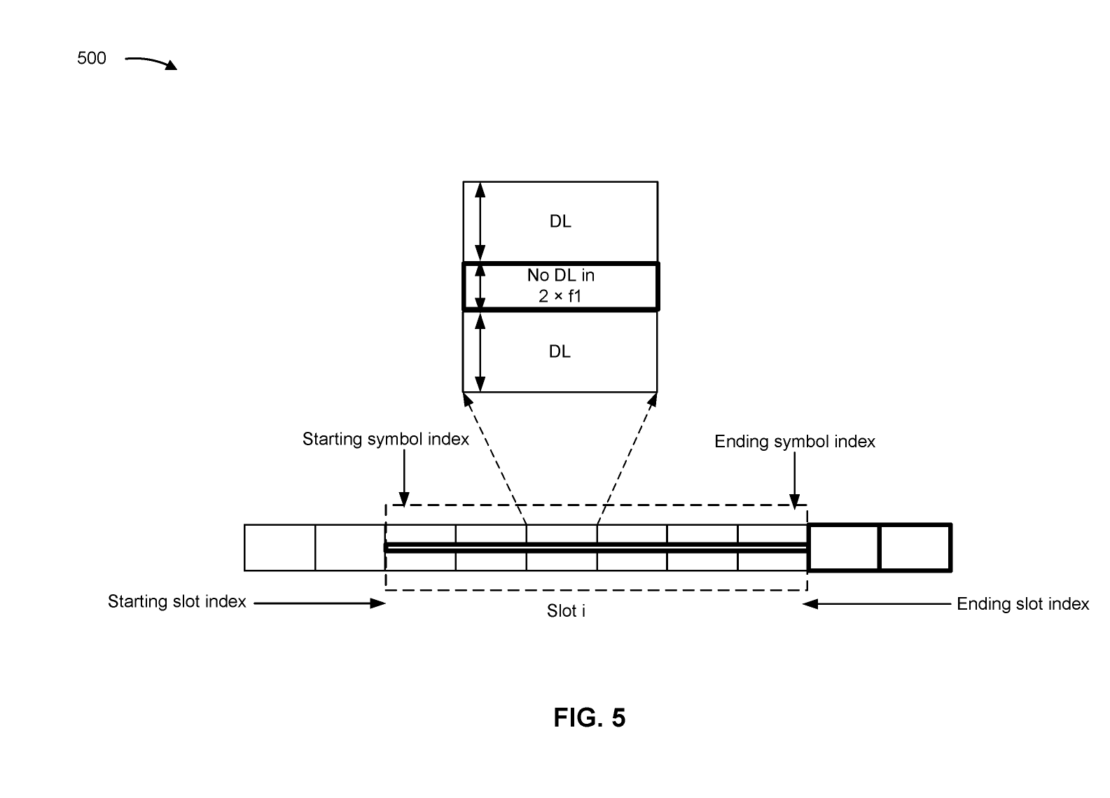

FIG. 5 is a diagram illustrating an example 500 of avoiding self-interference with SBFD.

Example 500 shows that, in some aspects for a consecutive manner time pattern (e.g., consecutive time slots), the network entity may indicate time resources (in the information) in which the UE is to avoid self-interference. The time resource may be where interference avoidance can be performed or where interference avoidance cannot be performed. An indication of where interference avoidance cannot be performed may implicitly indicate when interference avoidance can be performed. An indication of where interference avoidance can be performed may implicitly indicate when interference avoidance cannot be performed. The indication of the time resource may indicate a starting slot index, a starting symbol index within the starting slot, an ending slot index, and/or an ending symbol index within the ending slot. In some aspects, for a non-consecutive manner time pattern, the network entity may transmit a bitmap per symbol or per slot.

In some aspects, the network entity may transmit a frequency indication in the information. The frequency indication may be for a contiguous pattern and for a cell-specific configuration of frequency locations of each downlink subband in band A that cannot or can be used for downlink reception. There may be a frequency indication for each subcarrier spacing (SCS) configuration of multiple SCSs (e.g., SCS-SpecificCarrierList field for downlink). The frequency indication may include a starting resource block (RB) and a bandwidth of a downlink subband for each downlink subband. Downlink subband frequency resources within an active downlink BWP may be considered to be DL-usable PRBs in band A. Downlink receptions within downlink- usable PRBs are allowed. Downlink receptions outside of the DL-usable PRBs are not allowed.

In some aspects, the frequency indication may be for a non-contiguous pattern. If uplink transmission is scheduled via resource allocation type 0 with a non-contiguous pattern, then for a cell-specific configuration of frequency locations of each downlink subband in band A that cannot or can be used for downlink reception, the network entity may transmit a bitmap-based indication for each downlink subband. The frequency indication may be for each SCS configuration (e.g., in SCS-SpecificCarrierList for downlink).

In some aspects, there may be conditions for interference avoidance. For example, the use of a partial resource or a full resource in the slot for band A may be conditioned (first condition) on whether there is an actual transmission in uplink in the slot. In another example, the use of a partial resource or a full resource in the slot for band A may be conditioned (second condition) on whether the frequency resources in band A (twice the transmission bandwidth in band B as that of band A) is in-band with uplink frequency resource in band B in that slot. For example, N RBs at 3.5 GHz may cause interference for a UE’s own downlink reception at M (M ≥ N g. for intermodulation distortion (IMD) frequency 2 (IMD2), M = 2N, for IMD4, M = 4N …) RBs at 7 GHz band due to, for example, second harmonics.

In some aspects, a semi-static configuration may indicate the slot index for a slot during which downlink cannot be used for downlink reception and also indicate the associated frequency resources. The UE may implicitly further determine to apply interference avoidance based at least in part on the dynamic configuration per slot of the first condition and the second condition.

As indicated above, FIG. 5 is provided as an example. Other examples may differ from what is described with regard to FIG. 5.

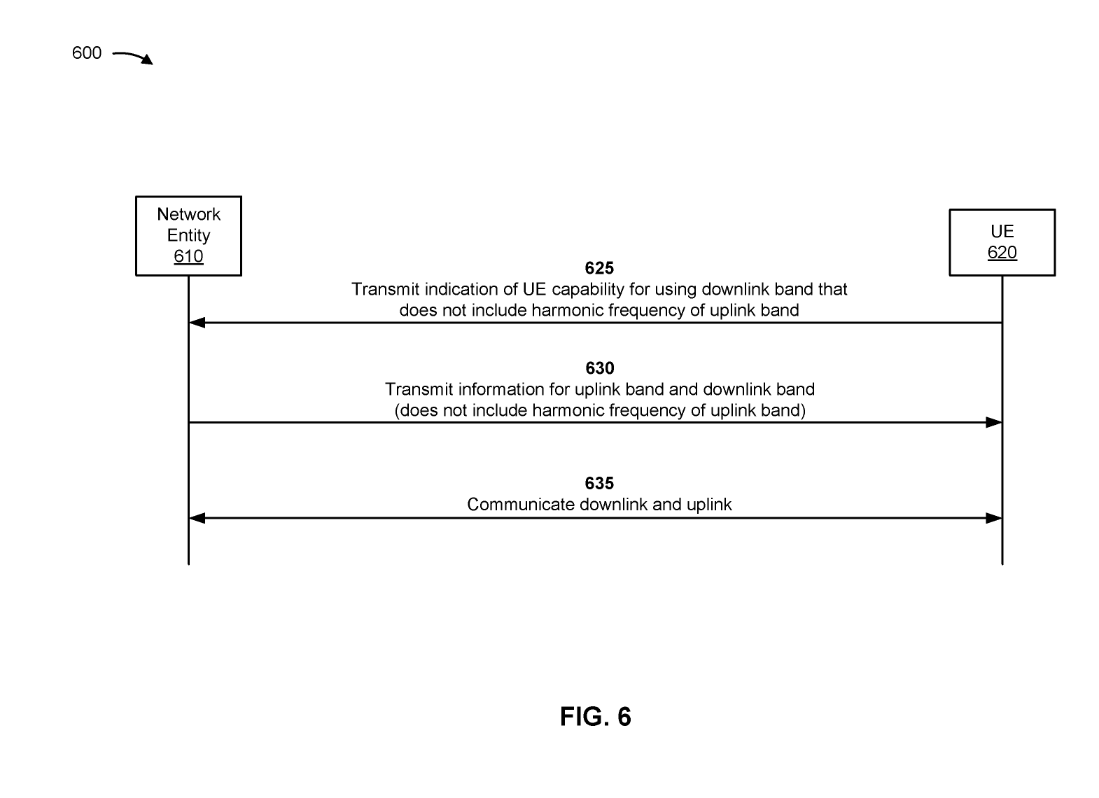

FIG. 6 is a diagram illustrating an example 600 associated with avoiding self-interference with SBFD. As shown in FIG. 6, a network entity 610 (e.g., network node 110) and a UE 620 (e.g., a UE 120) may communicate with one another via a wireless network (e.g., wireless communication network 100).

As shown by reference number 625, the UE 620 may transmit an indication of a UE capability for using a downlink band that does not include a harmonic frequency of an uplink band. The UE capability may be for semi-static interference avoidance or dynamic interference avoidance.

As shown by reference number 630, the network entity 610 may transmit information for an uplink band and a downlink band, where the downlink band does not include a harmonic frequency of the uplink band.

As shown by reference number 635, the UE 620 and the network entity 610 may communicate a message using the uplink band or the downlink band. If the message is to be on the downlink, the UE 620 may use the downlink band. If the message is to be on the uplink, the UE 620 may use the uplink band.

For example, the network entity 610 may indicate the symbol/slot index of a symbol or slot during which the downlink band cannot or can be used for downlink reception and also indicate the associated frequency resources. Uplink messages may still be transmitted by the same UE. Alternatively, in some aspects, uplink messages cannot be transmitted but downlink messages can still be received.

In some aspects, for 6G inter-band CA/DC, the UE 620 may be configured for uplink transmission in a C band (e.g., at 3.5 GHz), which can cause self-interference for the UE’s downlink reception (e.g., at 7 GHz band), due to, for example, 2nd harmonics. The formula for calculating the second harmonic frequency is f2 = 2 × f1, where f2 is the second harmonic frequency and f1 is the fundamental frequency. The 2nd harmonics indicates where the distortion falls. Inter-mod distortion 2 (IMD2) represents the second order of the distortion. For example, IMD2 and IMD4 can both fall on 2nd harmonics. In an example, if uplink transmission allocates 4 RBs in f1, then IMD2 leaks 2 × 4 RBs on f2 = 2f1, IMD4 leaks 4 × 4 RBs on f2 = 2f1, and the leakage/interference caused by IMD4 may be less than IMD2. The uplink transmission in band B leakage may be non-uniform in the reception in band A.

As indicated above, FIG. 6 is provided as an example. Other examples may differ from what is described with respect to FIG. 6.

FIG. 7 is a diagram illustrating an example process 700 performed, for example, at a UE or an apparatus of a UE. Example process 700 is an example where the apparatus or the UE (e.g., UE 620) performs operations associated with interference avoidance for SBFD.

As shown in FIG. 7, in some aspects, process 700 may include receiving information for an uplink band and a downlink band, wherein the downlink band does not include a harmonic frequency of a fundamental frequency of the uplink band (block 710). For example, the UE (e.g., using reception component 902 and/or communication manager 906, depicted in FIG. 9) may receive information for an uplink band and a downlink band, wherein the downlink band does not include a harmonic frequency of a fundamental frequency of the uplink band, as described above in connection with FIGS. 4-6.

As further shown in FIG. 7, in some aspects, process 700 may include communicating a message using the uplink band or the downlink band (block 720). For example, the UE (e.g., using reception component 902, transmission component 904, and/or communication manager 906, depicted in FIG. 9) may communicate a message using the uplink band or the downlink band, as described above in connection with FIGS. 4-6.

In some aspects, this may apply to or may be associated with an inter-band CA or DC operation. The uplink band may be in a B band or a C band, and the downlink band may be in an A band.

Process 700 may include additional aspects, such as any single aspect or any combination of aspects described below and/or in connection with one or more other processes described elsewhere herein.

In a first aspect, the information indicates a time resource or a frequency resource in which the message can be communicated or cannot be communicated.

In a second aspect, alone or in combination with the first aspect, the time resource includes one or more of a starting slot index, a starting symbol index, an ending slot index, or an ending symbol index.

In a third aspect, alone or in combination with one or more of the first and second aspects, the time resource includes a bitmap per symbol or a bitmap per slot.

In a fourth aspect, alone or in combination with one or more of the first through third aspects, the information is for the downlink band and not the uplink band, or for the uplink band and not he downlink band.

In a fifth aspect, alone or in combination with one or more of the first through fourth aspects, the information indicates a starting resource block index and a bandwidth of the downlink band for an SCS.

In a sixth aspect, alone or in combination with one or more of the first through fifth aspects, for a contiguous pattern associated with a cell-specific configuration, the information indicates usable PRBs for the downlink band overlapped with an active downlink bandwidth part.

In a seventh aspect, alone or in combination with one or more of the first through sixth aspects, for a non-contiguous pattern associated with a cell-specific configuration, the information indicates usable PRBs for the downlink band via a bitmap.

In an eighth aspect, alone or in combination with one or more of the first through seventh aspects, communicating the message includes receiving the message in the downlink band in a slot based at least in part on whether there is an uplink transmission in the slot.

In a ninth aspect, alone or in combination with one or more of the first through eighth aspects, communicating the message includes receiving the message in the downlink band in a slot based at least in part on whether frequency resources for the downlink band are interfered by uplink transmissions in the uplink band in the slot.

In a tenth aspect, alone or in combination with one or more of the first through ninth aspects, process 700 includes transmitting an indication of a UE capability of supporting inter-band carrier aggregation or dual connectivity that semi-statically avoids self-interference by using a downlink band that does not include a harmonic frequency of a fundamental frequency of the uplink band, and applying self-interference avoidance semi-statically.

In an eleventh aspect, alone or in combination with one or more of the first through tenth aspects, applying the self-interference avoidance semi-statically includes applying the self-interference avoidance further based at least in part on a dynamic configuration of an uplink transmission in a slot or whether a frequency resource for the downlink band overlaps with a frequency resource for the uplink band in the slot.

In a twelfth aspect, alone or in combination with one or more of the first through eleventh aspects, process 700 includes transmitting an indication of a UE capability of dynamically avoiding self-interference by using a downlink band that does not include a harmonic frequency of a fundamental frequency of the uplink band, and applying self-interference avoidance dynamically.

In a thirteenth aspect, alone or in combination with one or more of the first through twelfth aspects, process 700 includes using the uplink band and the downlink band as part of inter-band carrier aggregation or dual connectivity, and the uplink band is below 6 GHz for FR1 and the downlink band is between 6 GHz and 8 GHz for FR3.

In a fourteenth aspect, alone or in combination with one or more of the first through thirteenth aspects, the harmonic frequency is a second harmonic frequency of the fundamental frequency.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network entity or an apparatus of a network entity. Example process 800 is an example where the apparatus or the network entity (e.g., network entity 610) performs operations associated with interference avoidance for SBFD.

As shown in FIG. 8, in some aspects, process 800 may include transmitting information for an uplink band and a downlink band, where the downlink band does not include a harmonic frequency of a fundamental frequency of the uplink band (block 810). For example, the network entity (e.g., using transmission component 1004 and/or communication manager 1006, depicted in FIG. 10) may transmit information for an uplink band and a downlink band, where the downlink band does not include a harmonic frequency of a fundamental frequency of the uplink band, as described above in connection with FIGS. 4-6.

As further shown in FIG. 8, in some aspects, process 800 may include communicating a message using the uplink band or the downlink band (block 820). For example, the network entity (e.g., using reception component 1002, transmission component 1004, and/or communication manager 1006, depicted in FIG. 10) may communicate a message using the uplink band or the downlink band, as described above in connection with FIGS. 4-6.

In some aspects, this may apply to or may be associated with an inter-band CA or DC operation. The uplink band may be in a B band or a C band, and the downlink band may be in an A band.

Process 800 may include additional aspects, such as any single aspect or any combination of aspects described below and/or in connection with one or more other processes described elsewhere herein.

In a first aspect, the information indicates a time resource or a frequency resource in which the message can be communicated or cannot be communicated.

In a second aspect, alone or in combination with the first aspect, the time resource includes one or more of a starting slot index, a starting symbol index, an ending slot index, an ending symbol index, or a bitmap.

In a third aspect, alone or in combination with one or more of the first and second aspects, the information indicates a starting resource block index and a bandwidth of the downlink band for a subcarrier spacing.

In a fourth aspect, alone or in combination with one or more of the first through third aspects, for a contiguous pattern associated with a cell-specific configuration, the information indicates usable PRBs for the downlink band overlapped with an active downlink bandwidth part.

In a fifth aspect, alone or in combination with one or more of the first through fourth aspects, for a non-contiguous pattern associated with a cell-specific configuration, the information indicates usable physical resource blocks for the downlink band.

In a sixth aspect, alone or in combination with one or more of the first through fifth aspects, communicating the message includes transmitting the message in the downlink band in a slot based at least in part on whether there is an uplink transmission in the slot.

In a seventh aspect, alone or in combination with one or more of the first through sixth aspects, communicating the message includes transmitting the message in the downlink band in a slot based at least in part on whether frequency resources for the downlink band are interfered by uplink transmissions in the uplink band in the slot.

In an eighth aspect, alone or in combination with one or more of the first through seventh aspects, process 800 includes receiving an indication of a UE capability of using a downlink band that does not include a harmonic frequency of a fundamental frequency of the uplink band, and transmitting the information includes transmitting the information based at least in part on the UE capability.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive information for an uplink band and a downlink band, where the downlink band does not include a harmonic frequency of a fundamental frequency of the uplink band. The reception component 902 and/or the transmission component 904 may communicate a message using the uplink band or the downlink band.

The transmission component 904 may transmit an indication of a UE capability of semi-statically using a downlink band that semi-statically does not include a harmonic frequency of a fundamental frequency of the uplink band.

The transmission component 904 may transmit an indication of a UE capability of dynamically using a downlink band that dynamically does not include a harmonic frequency of a fundamental frequency of the uplink band.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network entity.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network entity described above in connection with FIG. 1, such as a radio, one or more RF chains, one or more transceivers, or one or more modems, each of which may in turn be coupled with one or more antennas of the network entity.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit information for an uplink band and a downlink band, where the downlink band does not include a harmonic frequency of a fundamental frequency of the uplink band. The reception component 1002 and/or the transmission component 1004 may communicate a message using the uplink band or the downlink band.

The reception component 1002 may receive an indication of a UE capability of using a downlink band that does not include a harmonic frequency of a fundamental frequency of the uplink band, and transmitting the information includes transmitting the information based at least in part on the UE capability.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving information for an uplink band and a downlink band, wherein the downlink band does not include a harmonic frequency of a fundamental frequency of the uplink band; and communicating a message using the uplink band or the downlink band.

Aspect 2: The method of Aspect 1, wherein the information indicates a time resource or a frequency resource in which the message can be communicated or cannot be communicated.

Aspect 3: The method of Aspect 2, wherein the time resource includes one or more of a starting slot index, a starting symbol index, an ending slot index, or an ending symbol index.

Aspect 4: The method of Aspect 2, wherein the time resource includes a bitmap per symbol or a bitmap per slot.

Aspect 5: The method of Aspect 2, wherein the information is for the downlink band and not the uplink band, or for the uplink band and not he downlink band.

Aspect 6: The method of any of Aspects 1-5, wherein the information indicates a starting resource block index and a bandwidth of the downlink band for a subcarrier spacing.

Aspect 7: The method of any of Aspects 1-6, wherein, for a contiguous pattern associated with a cell-specific configuration, the information indicates usable physical resource blocks for the downlink band overlapped with an active downlink bandwidth part.

Aspect 8: The method of any of Aspects 1-6, wherein, for a non-contiguous pattern associated with a cell-specific configuration, the information indicates usable physical resource blocks for the downlink band via a bitmap.

Aspect 9: The method of any of Aspects 1-8, wherein communicating the message includes receiving the message in the downlink band in a slot based at least in part on whether there is an uplink transmission in the slot.

Aspect 10: The method of any of Aspects 1-9, wherein communicating the message includes receiving the message in the downlink band in a slot based at least in part on whether frequency resources for the downlink band are interfered by uplink transmissions in the uplink band in the slot.

Aspect 11: The method of any of Aspects 1-10, further comprising: transmitting an indication of a UE capability of supporting inter-band carrier aggregation or dual connectivity that semi-statically avoids self-interference by using a downlink band that does not include a harmonic frequency of a fundamental frequency of the uplink band; and applying self-interference avoidance semi-statically.

Aspect 12: The method of Aspect 11, wherein applying the self-interference avoidance semi-statically includes applying the self-interference avoidance further based at least in part on a dynamic configuration of an uplink transmission in a slot or whether a frequency resource for the downlink band overlaps with a frequency resource for the uplink band in the slot.

Aspect 13: The method of any of Aspects 1-10, further comprising: transmitting an indication of a UE capability of dynamically avoiding self-interference by using a downlink band that does not include a harmonic frequency of a fundamental frequency of the uplink band; and applying self-interference avoidance dynamically.

Aspect 14: The method of any of Aspects 1-13, further comprising using the uplink band and the downlink band as part of inter-band carrier aggregation or dual connectivity, and wherein the uplink band is below 6 gigahertz (GHz) for frequency range 1 (FR1) and the downlink band is between 6 GHz and 8 GHz for frequency range 3 (FR3).

Aspect 15: The method of any of Aspects 1-14, wherein the harmonic frequency is a second harmonic frequency of the fundamental frequency.

Aspect 16: A method of wireless communication performed by a network entity, comprising: transmitting information for an uplink band and a downlink band, wherein the downlink band does not include a harmonic frequency of a fundamental frequency of the uplink band; and communicating a message using the uplink band or the downlink band.

Aspect 17: The method of Aspect 16, wherein the information indicates a time resource or a frequency resource in which the message can be communicated or cannot be communicated.

Aspect 18: The method of Aspect 17, wherein the time resource includes one or more of a starting slot index, a starting symbol index, an ending slot index, an ending symbol index, or a bitmap.

Aspect 19: The method of any of Aspects 16-18, wherein the information indicates a starting resource block index and a bandwidth of the downlink band for a subcarrier spacing.

Aspect 20: The method of any of Aspects 16-19, wherein, for a contiguous pattern associated with a cell-specific configuration, the information indicates usable physical resource blocks for the downlink band overlapped with an active downlink bandwidth part.

Aspect 21: The method of any of Aspects 16-19, wherein, for a non-contiguous pattern associated with a cell-specific configuration, the information indicates usable physical resource blocks for the downlink band.

Aspect 22: The method of any of Aspects 16-21, wherein communicating the message includes transmitting the message in the downlink band in a slot based at least in part on whether there is an uplink transmission in the slot.

Aspect 23: The method of any of Aspects 16-22, wherein communicating the message includes transmitting the message in the downlink band in a slot based at least in part on whether frequency resources for the downlink band are interfered by uplink transmissions in the uplink band in the slot.

Aspect 24: The method of any of Aspects 16-23, further comprising receiving an indication of a user equipment (UE) capability of using a downlink band that does not include a harmonic frequency of a fundamental frequency of the uplink band, and wherein transmitting the information includes transmitting the information based at least in part on the UE capability.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to cause the UE to:
receive information for an uplink band and a downlink band, wherein the downlink band does not include a harmonic frequency of a fundamental frequency of the uplink band; and
communicate a message using the uplink band or the downlink band.

2. The apparatus of claim 1, wherein the one or more processors are individually or collectively configured to cause the UE to transmit an indication of a UE capability of dynamically avoiding self-interference by using a downlink band that does not include a harmonic frequency of a fundamental frequency of the uplink band, and wherein the one or more processors are individually or collectively configured to cause the UE to apply self-interference avoidance dynamically.

3. The apparatus of claim 1, wherein the information indicates a time resource or a frequency resource in which the message can be communicated or cannot be communicated.

4. The apparatus of claim 3, wherein the time resource includes one or more of a starting slot index, a starting symbol index, an ending slot index, or an ending symbol index.

5. The apparatus of claim 3, wherein the time resource includes a bitmap per symbol or a bitmap per slot.

6. The apparatus of claim 3, wherein the information is for the downlink band and not the uplink band, or for the uplink band and not he downlink band.

7. The apparatus of claim 1, wherein the information indicates a starting resource block index and a bandwidth of the downlink band for a subcarrier spacing.

8. The apparatus of claim 1, wherein, for a contiguous pattern associated with a cell-specific configuration, the information indicates usable physical resource blocks for the downlink band overlapped with an active downlink bandwidth part.

9. The apparatus of claim 1, wherein, for a non-contiguous pattern associated with a cell-specific configuration, the information indicates usable physical resource blocks for the downlink band via a bitmap.

10. The apparatus of claim 1, wherein to communicate the message, the one or more processors are individually or collectively configured to cause the UE to receive the message in the downlink band in a slot based at least in part on whether there is an uplink transmission in the slot.

11. The apparatus of claim 1, wherein to communicate the message, the one or more processors are individually or collectively configured to cause the UE to receive the message in the downlink band in a slot based at least in part on whether frequency resources for the downlink band are interfered by uplink transmissions in the uplink band in the slot.

12. The apparatus of claim 1, wherein the one or more processors are individually or collectively configured to cause the UE to transmit an indication of a UE capability of supporting inter-band carrier aggregation or dual connectivity that semi-statically avoids self-interference by using a downlink band that does not include a harmonic frequency of a fundamental frequency of the uplink band, and wherein the one or more processors are individually or collectively configured to cause the UE to apply self-interference avoidance semi-statically.

13. The apparatus of claim 12, wherein to apply the self-interference avoidance semi-statically, the one or more processors are individually or collectively configured to cause the UE to apply the self-interference avoidance further based at least in part on a dynamic configuration of an uplink transmission in a slot or whether a frequency resource for the downlink band overlaps with a frequency resource for the uplink band in the slot.

14. The apparatus of claim 1, wherein the information indicates a time resource or a frequency resource in which the message can be communicated or cannot be communicated.

15. The apparatus of claim 1, wherein the one or more processors are individually or collectively configured to use the uplink band and the downlink band as part of inter-band carrier aggregation or dual connectivity, and wherein the uplink band is below 6 gigahertz (GHz) for frequency range 1 (FR1) and the downlink band is between 6 GHz and 8 GHz for frequency range 3 (FR3).

16. An apparatus for wireless communication at a network entity, comprising:
one or more memories; and
one or more processors, coupled to the one or more memories, individually or collectively configured to cause the network entity to:
transmit information for an uplink band and a downlink band, wherein the downlink band does not include a harmonic frequency of a fundamental frequency of the uplink band; and
communicate a message using the uplink band or the downlink band.

17. The apparatus of claim 16, wherein the information indicates a time resource or a frequency resource in which the message can be communicated or cannot be communicated.

18. The apparatus of claim 16, wherein to communicate the message, the one or more processors are individually or collectively configured to cause the network entity to transmit the message in the downlink band in a slot based at least in part on whether there is an uplink transmission in the slot.

19. The apparatus of claim 16, wherein to communicate the message, the one or more processors are individually or collectively configured to cause the network entity to transmit the message in the downlink band in a slot based at least in part on whether frequency resources for the downlink band are interfered by uplink transmissions in the uplink band in the slot.

20. The apparatus of claim 16, wherein the one or more processors are individually or collectively configured to cause the network entity to receive an indication of a user equipment (UE) capability of using a downlink band that does not include a harmonic frequency of a fundamental frequency of the uplink band, and wherein to transmit the information, the one or more processors are individually or collectively configured to cause the network entity to transmit the information based at least in part on the UE capability.
